(19) United States
(12) Patent Application Publication
(10) Pub. No.: US 2009/0034125 A1
(43) Pub. Date: Feb. 5, 2009

(54) Load/unload ramp spoiler for a hard disk drive

(76) Inventors: Andre S. Chan, Milpitas, CA (US); Ferdinand Hendriks, Morgan Hill, CA (US); Brad V. Johnson, Santa Clara, CA (US); Jung Seo Park, San Jose, CA (US)

Correspondence Address: HITACHI C/O WAGNER BLECHER LLP, 123 WESTRIDGE DRIVE, WATSONVILLE, CA, 95076, US

(21) Appl. No.: 11/888,417

(22) Filed: Jul. 31, 2007

(51) Int. Cl. G11B 5/60

(52) U.S. Cl. 360/235.4

(57) ABSTRACT

A load/unload ramp spoiler for a hard disk drive is disclosed. One embodiment provides a load/unload ramp body having at least one load/unload ramp associated therewith, the at least one load/unload ramp for receiving at least one slider coupled with an actuator assembly. In addition, at least one spoiler is integrated with the load/unload ramp body to reduce detrimental local excitation of an airflow encountering the load/unload ramp body.

### TECHNICAL FIELD

The present invention relates to the field of hard disk drive development, and more particularly to a method and system for utilizing a load/unload ramp spoiler in a hard disk drive.

### BACKGROUND ART

At least one hard disk drive (HDD) is used in almost all computer system operations. In fact, most computing systems are not operational without some type of HDD to store the most basic computing information such as the boot operation, the operating system, the applications, and the like. In general, the HDD is a device which may or may not be removable, but without which the computing system will generally not operate.

The basic HDD model includes a storage disk or hard disk that spins at a designed rotational speed. An actuator arm with a suspended slider is utilized to reach out over the disk. The slider is coupled with a suspension that supports both the body of the slider and a head assembly that has a magnetic read/write transducer or head or heads for reading/writing information to or from a location on the disk. The complete head assembly, e.g., the suspension, slider, and head, is called a head gimbal assembly (HGA).

In operation, the hard disk is rotated at a set speed via a spindle motor assembly having a central drive hub. There are tracks at known intervals across the disk. When a request for a read of a specific portion or track is received, the hard disk aligns the head, via the arm, over the specific track location and the head reads the information from the disk. In the same manner, when a request for a write of a specific portion or track is received, the hard disk aligns the head, via the arm, over the specific track location and the head writes the information to the disk.

Over the years, the disk and the head have undergone great reductions in their size. Much of the refinement has been driven by consumer demand for smaller and more portable HDDs such as those used in personal digital assistants (PDAs), Moving Picture Experts Group audio layer 3 (MP3) players, and the like. For example, the original HDD had a disk diameter of 24 inches. Modern HDDs are much smaller and include disk diameters of less than 2.5 inches. Advances in magnetic recording are also primary reasons for the reduction in size.

A second refinement to the HDD is the increased efficiency and reduced size of the spindle motor spinning the disk. That is, as technology has reduced motor size and power draw for small motors, the mechanical portion of the HDD can be reduced and additional revolutions per minute (RPMs) can be achieved. For example, it is not uncommon for a HDD to reach speeds of 15,000 RPMs. This second refinement provides weight and size reductions to the HDD, it also provides a faster read and write rate for the disk thereby providing increased speed for accessing data. The increase in data acquisition speed due to the increased RPMs of the HDD and the more efficient read/write head portion provide modern computers with hard disk speed and storage capabilities that are continually increasing.

However, the higher RPMs of the disk have resulted in problems with respect to the interaction of the air with components of the HDD. For example, although the HDD is closed off from the outside, it has an amount of air within its packaging. As the disk spins and the RPMs increase, the air within the HDD package will also begin to rotate and will eventually approach the speed at which the disk is rotating especially near the spindle hub and disk surfaces. This is due to the friction between the disk and the air. In general, Reynolds numbers are used to represent the flow characteristics. For example, in one case the Reynolds number may be based on the tip speed of the disk. That is, the linear velocity at the outer diameter of the disk.

Only when the Reynolds number is sufficiently small (e.g., an enclosure with reduced air density), the air may stay in steady flow with the boundary layer of air remaining smooth with respect to the rotating disk. However, any obstructions to the flow will result in turbulence.

As is well known from fluid dynamics, the characteristics of turbulent airflow can include buffeting, harmonic vibration, and the like. Each of these characteristics will result in problematic motion for the arm and head portion and/or the rotating disk. The problematic motion will result in excessive track miss-registration. This is even more significant as the tolerances are further reduced.

Currently, significant efforts are put into HDD design to minimize the problem caused by unsteady air flow such as airflow bypass channel designs and spoiler designs. For example, present HDD designs can have as many as four airflow components (upstream spoiler, downstream spoiler, slit shroud, and bypass channel), and each one of these components adds cost and manufacturing time.

### SUMMARY

A load/unload ramp spoiler for a hard disk drive is disclosed. One embodiment provides a load/unload ramp body having at least one load/unload ramp associated therewith, the at least one load/unload ramp for receiving at least one slider coupled with an actuator assembly. In addition, at least one spoiler is integrated with the load/unload ramp body to reduce detrimental local excitation of an airflow encountering the load/unload ramp body.

### BRIEF DESCRIPTION OF THE DRAWINGS

FIG. 1A is a plan view of a HDD with cover and top magnet removed in accordance with one embodiment of the present invention.

FIG. 1B is an isometric blow-apart of a HDD in accordance with one embodiment of the present invention.

FIG. 2A is a block diagram illustrating airflow around a L/UL ramp body having no integrated spoiler is shown.

FIG. 2B is a block diagram illustrating airflow around a L/UL ramp body having at least one integrated spoiler in accordance with one embodiment of the present invention.

FIG. 3A is a block diagram of a load/unload ramp, including an integrated spoiler having a first shape, in accordance with one embodiment of the present invention.

FIG. 3B is a block diagram of a load/unload ramp, including an integrated spoiler having a second shape, in accordance with one embodiment of the present invention.

FIG. 3C is a block diagram of a load/unload ramp, including an integrated spoiler having a third shape, in accordance with one embodiment of the present invention.

FIG. 3D is a block diagram of a load/unload ramp, including an integrated spoiler having a fourth shape, in accordance with one embodiment of the present invention.

FIG. 4 is a flowchart of a method for utilizing a load/unload ramp spoiler in a HDD in accordance with one embodiment of the present invention.

### BEST MODES FOR CARRYING OUT THE INVENTION

Reference will now be made in detail to the alternative embodiment(s) of the present invention. While the invention will be described in conjunction with the alternative embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

The discussion will begin with an overview of a HDD and components connected therewith. The discussion will then focus on embodiments of a method and system for utilizing a load/unload ramp spoiler to improve actuator dynamics, such as, flow induced vibration of a slider, an integrated lead suspension (ILS) trace and/or suspension components of a head gimbal assembly in particular.

### Overview

In general, the integrated spoiler-finger load/unload ramp effectively reduces non-repeatable runout (NRRO) and track-follow track misregistration (TMR) caused by unsteady airflow and at the same time reduces cost, manufacturing assembly time, and is more effective in suppressing flow induced vibration of the slider, ILS trace and suspension components because its of its flow stagnation (“upstream waken).

With spindle motor/disk packs rotating at 15 k RPM, flow induced vibrations are the major detractor to HDD performance. With newer slider designs (Femto) that have much smaller air-bearing surface, the load/unload (L/UL) ramp becomes an essential component in preventing head/disk damage from non-operational shocks.

The presence of the L/UL ramp at the outer diameter (OD) of the disk makes the effects of airflow even more problematic when reading/writing at the OD. In prior art implementations, the L/UL ramp acts aerodynamically as an air break, consuming substantial aerodynamic power. However, utilization of the present technology suppresses flow induced vibration of (especially) the sensitive suspension, ILS and slider components. Moreover, if the present technology is used in conjunction with an aerodynamic bypass, the flow in the bypass channel will be increased. In addition, if the aerodynamic bypass includes a filter, such as a filter in the bypass wall, the flow through the filter will also be increased, resulting in reduced particle cleanup time.

### Operation

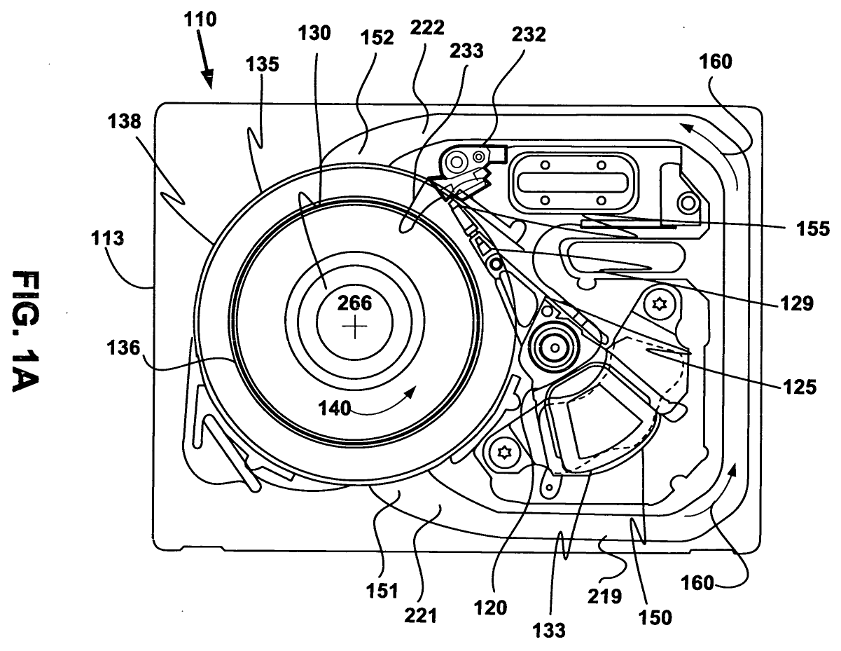

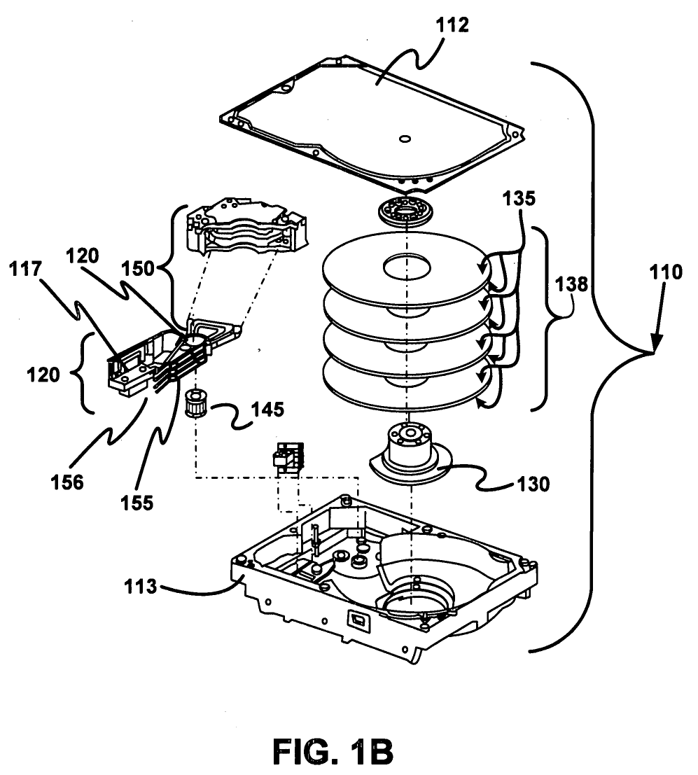

With reference now to FIG. 1A, a schematic drawing of one embodiment of an information storage system including a magnetic hard disk file or HDD 110 for a computer system is shown. HDD 110 has an outer housing or base 113 containing a disk pack having at least one media or magnetic disk 138. The disk pack (as represented by disk 138) defines an axis of rotation and a radial direction relative to the axis in which the disk pack is rotatable. That is, although only one disk 138 is shown, any number of disks 138 may be utilized within HDD 110. In other words, throughout the present description, whenever a single disk 138 is discussed, it is understood that the discussion may be directed toward one disk 138 or a plurality of disks 138.

A spindle motor assembly having a central drive hub 130 operates as this axis and rotates the disk 138 or disks of the disk pack in the radial direction relative to housing 113. An actuator assembly 120 includes a plurality of parallel actuator arms 125 in the form of a comb that is movably or pivotally mounted to base/housing 113 about a pivot assembly 145. A controller 150 is also mounted to base 113 for selectively moving the comb of arms relative to disk 138.

In the embodiment shown in FIG. 1A, each arm 125 has extending from it at least one cantilevered integrated lead suspension (ILS) 129. The ILS 129 may be any form of lead suspension that can be used in a data access storage device, such as HDD 110. The slider 155 is usually bonded to the end of ILS 129. The level of integration containing the slider, suspension, ILS, and read/write head (not shown) is called the Head Gimbal Assembly (HGA).

The ILS 129 has a spring-like quality, which biases or presses the air-bearing surface of slider 155 against disk 138 to cause slider 155 to fly at a precise distance from disk 138. ILS 129 has a hinge area that provides for the spring-like quality, and a flexing interconnect that supports read and write traces and electrical connections through the hinge area. A voice coil 133, free to move within a conventional voice coil motor magnet assembly, is also mounted to actuator arms 125 opposite the head gimbal assemblies. Movement of the actuator 120 by controller 150 causes the head gimbal assemblies to move along radial arcs across tracks on the surface 135 of disk. The head gimbal assemblies operate in a conventional manner and always move in unison with one another, unless HDD 110 uses multiple independent actuators (not shown) wherein the arms can move independently of one another.

HDD 110 also includes L/UL ramp body 232 with at least one integrated spoiler 233. In general, the L/UL ramp body 232 serves as a platform on which the ILS 129 and more specifically, slider 155 is able to rest when disk 138 is not spinning at operating speed. In one embodiment spoiler 233 may reach all of the way from OD 135 to the middle diameter (MD) 136.

The terms “middle diameter” and “outer diameter” are intended to be for illustrative purposes only. For example, the term MD 136 referrers to a portion of disk 138 that approximates the middle of the writable area of disk 138. In addition, the term OD 135 refers to a portion of disk 138 that approximates the outer portion of the writable area of disk 138. In another embodiment, the approximation may be based on the entire disk 138 without accounting for the writable area of disk 138.

Referring still to FIG. 1A, in one embodiment, HDD 110 also includes a bypass channel in addition to L/UL ramp body 232 having at least one spoiler 233 fixedly integrated therewith. In general, the disk 138 has an axis of rotation 266 and a direction of rotation 140 relative to the axis 266. In one embodiment, bypass channel 219 is located between an outer perimeter of the housing 113 and the actuator assembly 120, such that the bypass channel 219 completely circumscribes the actuator assembly 120. Generally, bypass channel 219 includes an inlet proximate to upstream side 151 wherein air is conveyed away from the disk 138 and at least one outlet proximate to downstream side 152 wherein airflow 160 is directed back toward the disk 138.

In one embodiment, bypass channel 219 may include a diffuser 221. In one embodiment, diffuser 221 is located adjacent to the upstream side 151 of disk 138. In general, diffuser 221 is offset upstream from disk 138, such that the diffuser 221 reduces airflow drag from the disk 138 due to disk wake in the bypass channel 219. This type of aerodynamic drag is commonly called base drag.

In addition, bypass channel 219 may also include a contraction 222 for re-accelerating bypass airflow 160 to provide efficient energy conversion for the air flow from pressure energy to kinetic energy prior to merging bypass airflow 160 with air flow 140 around the disk 138. Each of the diffuser 221 and the contraction 222 may be spaced apart from the outer edges of the disks 138, for example, approximately 0.5 mm.

The use of bypass channel 219 has several advantages, including the ability to reduce aerodynamic buffeting of actuator 120 during the servo writing process and/or during normal operation of HDD 110. More specifically, bypass channel 219 reduces the pressure build-up on the upstream side of actuator 120 which occurs when HDD 110 is operated. Additionally, directing airflow 140 into the bypass channel 219 decreases the upstream pressure on the actuator, thus reducing force acting on the actuator 120 while reducing the energy of the bluff-body wake of the actuator arm.

In embodiments of the present invention, HDD 110 may be filled with a gas (e.g., helium) rather than ambient air. This may be advantageous in that helium is a lighter gas than ambient air and causes less buffeting of actuator 120 when HDD 110 is in operation. In embodiments of the present invention, HDD 110 may be sealed after the servo writing process to keep the helium in the HDD.

FIG. 1A being a plan view shows only one head and one disk surface combination. One skilled in the art understands that what is described for one head-disk combination applies to multiple head-disk combinations. The embodied invention is independent of the number of head-disk combinations.

With reference now to FIG. 1B, a similar HDD 110 is shown, but with all its components in an isometric blow-apart view. The components, such as the plurality of hard disks 138, are assembled into base casting 113, which provides coupling points for components and sub-assemblies such as disk stack 138, voice coil motor (VCM) 150, and actuator assembly 120. Disks 138 are stacked and then coupled to base casting 113 by means of motor-hub assembly 130. Part connector 117 is utilized to convey data between arm electronics and a host system wherein HDD 110 resides.

Actuator assembly 120 is coupled pivotally to base casting 113 by means of pivot bearing 145, whereby VCM 150 can move head 156 accurately across data tracks on disk 138. Upon assembly of actuator assembly 120, disk(s) 138, VCM 150, and other components with base casting 113, cover 112 is coupled to base casting 113 to enclose these components and sub-assemblies into HDD 110.

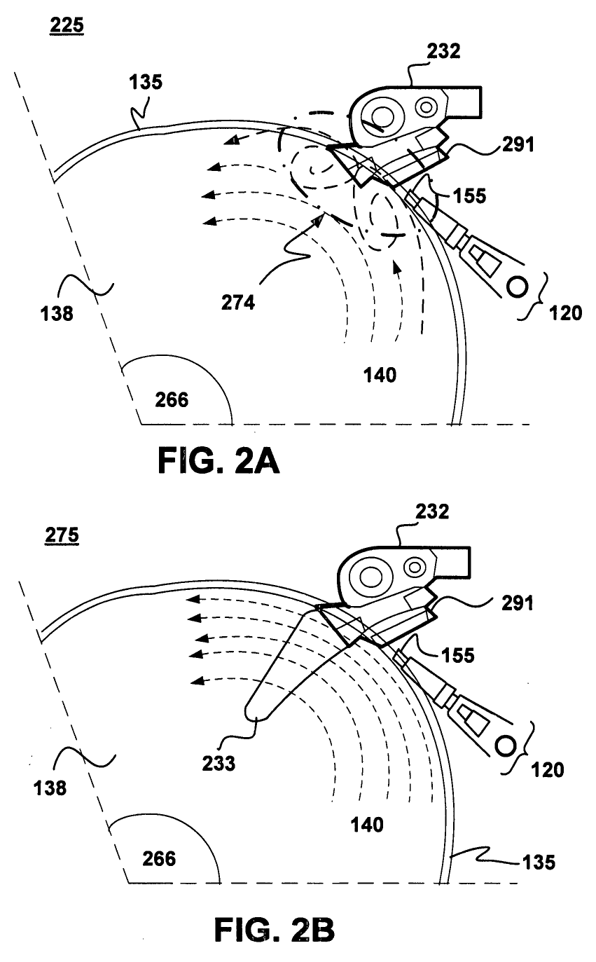

Referring now to FIG. 2A, an airflow diagram 225 illustrating airflow around a L/UL ramp body 232 having no integrated spoiler is shown. Airflow diagram 225 includes a portion of disk 138 and a portion of actuator assembly 120 including slider 155. In general, airflow diagram 225 illustrates one example of an airflow disruption area 274 caused by the airflow 140 encountering L/UL ramp body 232. For example, airflow disruption area 274 may be a flow stagnation area that includes upstream and downstream vortices that exacerbate the flow induced vibration on the surrounding structures, including the head gimbal assemblies.

Thus, as slider 155 moves closer to OD 135, slider 155 will begin to encounter airflow disruption area 274 and the flow induced vibrations associated therewith. As slider 155 moves further toward OD 135 and further into airflow disruption area 274, the associated flow induced vibrations will continue to increase. As stated herein, as flow induced vibrations increase, so do NRRO and TMR. Moreover, as HDD designs continue to increase the RPM of disk 138, airflow disruption area 274 will increase in both size and strength, thereby causing flow induced vibration of slider 155, and other components of actuator assembly 120, significantly earlier than OD 135. Moreover, as HDD size decreases, airflow disruption area 274 will remain constant, thereby actually increasing the distance between the initial effects of airflow disruption area 274 as felt on slider 155 and the tracks remaining before slider 155 reaches OD 135.

With reference now to FIG. 2B, airflow diagram 275 illustrating airflow around a L/UL ramp body 232 having at least one integrated spoiler 233 is shown in accordance with one embodiment of the present invention. In general, the integrated L/UL and downstream spoiler structure 233 create a zone of increased pressure and reduced velocity ahead of the integrated L/UL ramp body 232 and downstream spoiler structure 233. The increased pressure and reduced velocity suppress turbulent fluctuations near the suspension and gimbal area of the actuator suspension, which in turn reduces flow excited vibrations of the most flexible and turbulence-susceptible part of the actuator.

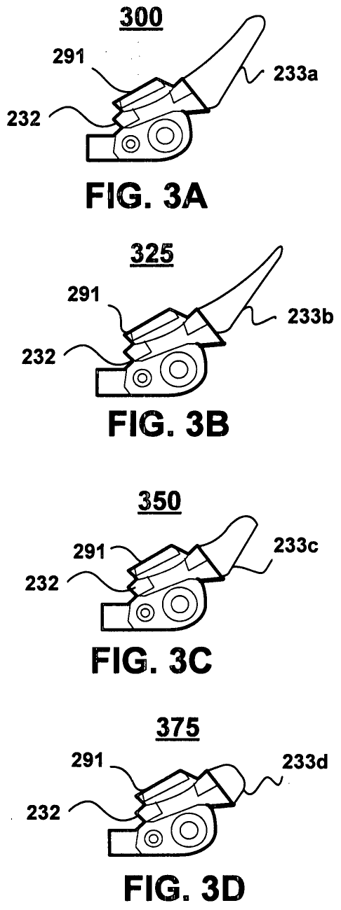

Referring now to FIG. 3A, a top view of the L/UL ramp assembly 300, including a L/UL ramp 291 and an integrated spoiler 233 having a first shape 233a is shown in accordance with one embodiment of the present invention. In one embodiment, spoiler 233 has a contoured shape (e.g., aerodynamic shape) wherein the cord length of spoiler 233 is longer toward the root portion and shorter toward the tip portion. For example, the spoiler 233a may extend to approximately track 55k. In one embodiment, spoiler 233a may be approximately 1.10 mm thick at the root.

Although approximate lengths and thicknesses are provided herein, they are merely a few of the possible embodiment and are provided for purposes of clarity. That is, the present technology is well suited to other length, width and thicknesses metrics and combinations of different variations with respect to each metric.

FIG. 3B is a top view of the L/UL ramp assembly 325, including L/UL ramp 291 and an integrated spoiler 233 having a second shape 233b, in accordance with one embodiment of the present invention. In one embodiment, spoiler 233a is shaped like a Chamfered Finger-full (0.55×45°) chamfers, leading and trailing edges

FIG. 3C is a top view of the L/UL ramp assembly 350, including L/UL ramp 291 and an integrated spoiler 233 having a third shape 233c, in accordance with another embodiment of the present invention. In one embodiment, spoiler 233a is shaped like a Medium Finger-extend to about track 30k

FIG. 3D is a top view of the L/UL ramp assembly 375, including L/UL ramp 291 and an integrated spoiler 233 having a fourth shape 233d, in accordance with another embodiment of the present invention. In one embodiment, spoiler 233a is shaped like a short finger. That is, because of the short length of spoiler 233d, L/UL ramp assembly 375 does not require rotary installation in the HDD.

In one embodiment, the shape of spoiler 233 may be somewhat smaller than, but still follow the shape of, a portion of the arc actuator arm 125 circumscribes across disk 138. In one embodiment, the design or shape of spoiler 233 may be based on dimensional tolerances, the accommodation of manufacturing tooling requirements, and the like. In yet another embodiment, the shape of spoiler 233 may be any shape and not directly related to, or based on, the shape of actuator arm 125.

Although, in FIGS. 3A-3D, only one spoiler 233 is shown integral with L/UL ramp body 232, it is appreciated that the L/UL ramp body 232 may include any number of L/UL ramps 291. Moreover, the present technology is independent of the actual number of L/UL ramps 291 associated with L/UL ramp body 232. Furthermore, the present technology is independent of the actual number of spoiler(s) 233 associated with L/UL ramp body 232. For example, L/UL ramp body 232 may include three L/UL ramps 291 and have a one-to-one ratio of spoilers 233 to L/UL ramps 291. In other words, there may be three L/UL ramps 291 and three spoilers 233. However, in another embodiment, the ratio of spoiler(s) 233 to L/UL ramps 291 may be less than one-to-one or greater than one-to one. For example, their may be 3 L/UL ramps 291 and 2 spoiler(s) 233, or there may be 1 L/UL ramp 291 and 2 spoiler(s) 233, or any of a multitude of other combinations.

In addition, while a number of spoiler 233 shapes are illustrated herein, this is not meant to be, and should not be, construed as a limitation of the shape of spoiler 233, Instead, it should be realized that it would be impossible to provide each and every shape to which spoiler 233 may be formed and the provided examples are merely for purposes of clarity.

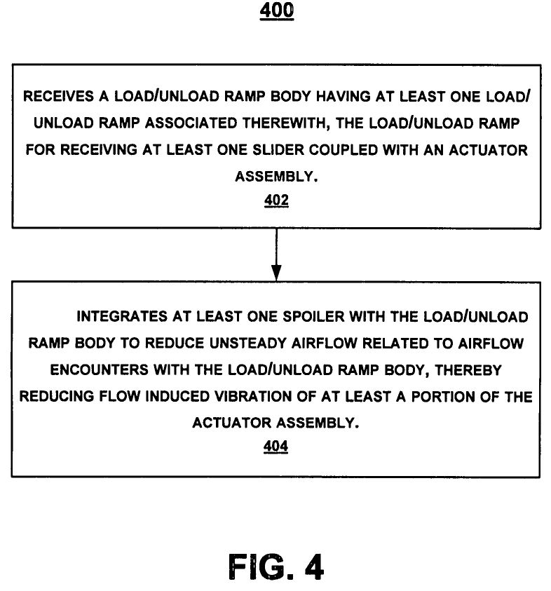

Referring now to FIG. 4 and FIGS. 2A and 2B, a flowchart of a method for utilizing a L/UL ramp spoiler 233 to reducing induced vibration related to airflow 140 encounters with a L/UL ramp 291 of a HDD is shown in accordance with one embodiment of the present invention. In general, the present technology reduces flow induced vibration of slider 155, integrated lead suspension (ILS) 129, suspension components of the HGA, additional components of actuator assembly 120, and the like. Additionally, a L/UL ramp body 232 with integrated spoiler 233 effectively reduces NRRO and track-follow TMR caused by unsteady airflow 274 especially as the slider approaches OD 135 of disk 138.

With reference now to 402 of FIG. 4 and to FIG. 2B, one embodiment receives a L/UL ramp body 232 having at least one L/UL ramp 291 associated therewith, the at least one L/UL ramp 291 for receiving at least one slider coupled with an actuator assembly. In another embodiment, L/UL ramp body 232 has a plurality of L/UL ramps 291 associated therewith.

Referring now to 404 of FIG. 4 and to FIG. 2B, one embodiment provides at least one spoiler 233 with the L/UL ramp body 232 to reduce unsteady airflow 274, of FIG. 2A, related to airflow 140 encounters with the L/UL ramp body 232, thereby reducing flow induced vibration of at least a portion of the actuator assembly. For example, the flow induced vibration may be induced on at least one of the slider(s) 155, a portion of an integrated lead suspension trace coupled with the actuator assembly, a suspension components coupled with the actuator assembly or any number or combination thereof.

In one embodiment, a plurality of spoilers 233 is integrated with L/UL ramp body 232. For example, the number of spoilers 233 may equal number of L/UL ramps 291. However, as stated herein, the number of spoilers 233 may also be greater or less than the number of L/UL ramps 291 present on the L/UL ramp body 232. In general, the leading edge of the at least one spoiler 233 is formed in the shape of an arc generated by a motion of the slider with respect to a surface of at least one disk.

Additionally, in one embodiment, the present technology also utilizes bypass channel 219 formed in housing 113 of HDD 110, to provide additional control of airflow 140. In addition, as described in FIG. 1A, a diffuser 221 may be coupled with a housing of HDD 110, the diffuser 221 providing additional control of airflow 140 generated by the rotating of at least one disk 138. Furthermore, one embodiment provides a contraction 222 coupled with the housing, the contraction 222 providing additional control of the airflow 140 generated by the rotating of the at least one disk.

Thus, embodiments of the present invention provide a method and apparatus for utilizing a L/UL ramp spoiler to improve actuator dynamics, such as, flow induced vibration of a slider, an integrated lead suspension (ILS) trace and/or suspension components of a head gimbal assembly in particular. Additionally, a L/UL ramp body with integrated spoiler-finger effectively reduces NRRO and track-follow TMR caused by unsteady airflow. That is, the existence of the L/UL ramp body with integrated spoiler significantly improves the flow of air in and around the area of L/UL ramp.

Moreover, the present embodiments provide significant airflow improvements while remaining within the already limiting constraints of HDD real estate. Moreover, the benefits described herein are realized with minimal modification to the overall HDD manufacturing process in general and to the L/UL ramp structure manufacturing process in particular reduces part cost and manufacturing assembly time.

Example embodiments of the present technology are thus described. Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A load/unload ramp spoiler for a hard disk drive comprising:
a load/unload ramp body having at least one load/unload ramp associated therewith, said at least one load/unload ramp for receiving at least one slider coupled with an actuator assembly; and
at least one spoiler integrated with said at least one load/unload ramp body, said at least one spoiler for reducing detrimental local excitation of an airflow encountering the load/unload ramp body.

2. The load/unload ramp spoiler of claim 1 wherein said airflow is generated by a rotating of a disk and said at least one spoiler comprises an aerodynamically shaped leading edge with respect to a direction of rotation of said disk.

3. The load/unload ramp spoiler of claim 1 further comprising:
a plurality of load/unload ramps associated with said load/unload ramp body, and
a plurality of spoilers equal to said plurality of load/unload ramps, wherein said plurality of spoilers are integrated with said load/unload ramp body.

4. The load/unload ramp spoiler of claim 1 wherein a leading edge of said at least one spoiler is formed in the shape of an arc generated by a motion of said at least one slider with respect to said disk.

5. The load/unload ramp spoiler of claim 1 wherein a leading edge of said at least one spoiler is formed in the shape of an arc generated by a motion of said actuator assembly with respect to said disk.

6. The load/unload ramp spoiler of claim 1 wherein a clearance between a leading edge of said at least one spoiler and said at least one slider is approximately 0.5 millimeters.

7. The load/unload ramp spoiler of claim 1 wherein said detrimental local excitation is selected from the group consisting of: flow induced vibration of said at least one slider, flow induced vibration of an integrated lead suspension trace coupled with said actuator assembly, or flow induced vibration of suspension components coupled with said actuator assembly.

8. A hard disk drive comprising:
a housing;
a disk pack mounted to the housing and having a plurality of disks that are rotatable relative to the housing, the disk pack defining an axis of rotation and a radial direction relative to the axis, wherein the rotating of said plurality of disks generates an airflow;
an actuator mounted to the housing and being movable relative to the disk pack, the actuator having a plurality of sliders thereon;
a load/unload ramp body coupled with said housing, said load/unload ramp body having a plurality of load/unload ramps for receiving said plurality of sliders; and
at least one spoiler fixedly coupled with said load/unload ramp body, said at least one spoiler for reducing detrimental local excitation of said airflow when said airflow interacts with said load/unload ramp body.

9. The hard disk drive of claim 8 further comprising:
a bypass channel formed in the housing, said bypass channel providing additional control of the airflow generated by the rotating of said plurality of disks.

10. The hard disk drive of claim 8 further comprising:
a diffuser coupled with the housing, said diffuser providing additional control of the airflow generated by the rotating of said plurality of disks.

11. The hard disk drive of claim 8 further comprising:
a contraction coupled with the housing, said contraction providing additional control of the airflow generated by the rotating of said plurality of disks.

12. The hard disk drive of claim 8 further comprising:
a plurality of spoilers equal in number to said plurality of load/unload ramps, said plurality of spoilers fixedly coupled with said load/unload ramp body, said plurality of spoilers for reducing local excitation of said airflow when said airflow interacts with said load/unload ramp body.

13. The hard disk drive of claim 8 wherein a leading edge of said at least one spoiler is formed in the shape of an arc generated by a motion of said slider with respect to a surface of at least one of said plurality of disks.

14. The hard disk drive of claim 8 wherein a clearance between a leading edge of said at least one spoiler and said at least one slider is approximately 0.5 millimeters.

15. A method for reducing flow induced vibration related to airflow encounters with a load/unload ramp of a hard disk drive, said method comprising:
receiving a load/unload ramp body having at least one load/unload ramp associated therewith, said at least one load/unload ramp for receiving at least one slider coupled with an actuator assembly; and
providing at least one spoiler with said load/unload ramp body to reduce unsteady airflow related to airflow encounters with said load/unload ramp body, thereby reducing flow induced vibration of at least a portion of said actuator assembly.

16. The method as described in claim 15 further comprising:
forming a bypass channel in a housing of said hard disk drive, said bypass channel providing additional control of the airflow.

17. The method as described in claim 15 further comprising:
receiving a load/unload ramp body having a plurality of load/unload ramps associated therewith, and
providing a plurality of spoilers, equal to said plurality of load/unload ramps, with said load/unload ramp body.

18. The method as described in claim 15 further comprising:
forming a leading edge of said at least one spoiler in the shape of an arc generated by a motion of said slider with respect to a surface of at least one disk.

19. The method as described in claim 15 further comprising:
utilizing a diffuser coupled with a housing of said hard disk drive, said diffuser providing additional control of the airflow generated by the rotating of at least one disk; and
utilizing a contraction coupled with the housing, said contraction providing additional control of the airflow generated by the rotating of said at least one disk.

20. The method as described in claim 15 wherein said flow induced vibration is selected from the group consisting of: flow induced vibration of said at least one slider, flow induced vibration of an integrated lead suspension trace coupled with said actuator assembly, or flow induced vibration of suspension components coupled with said actuator assembly.
